(19) United States
(12) Patent Application Publication
(10) Pub. No.: US 2026/0175476 A1
(43) Pub. Date: Jun. 25, 2026

(54) FOAMED CONTAINER

(71) Applicant: SABIC GLOBAL TECHNOLOGIES B.V., Bergen op Zoom (NL)

(72) Inventors: KAR Raymond CHU, Maastricht (NL); Emanuel Joseph Herman Marie VAN DER VEN, Waalre (NL)

(21) Appl. No.: 19/126,835

(22) PCT Filed: Nov. 3, 2023
(86) PCT No.: PCT/EP2023/080685

§ 371 Date: May 2, 2025

(30) Foreign Application Priority Data
Nov. 4, 2022 (EP) 22205600.4

(51) Int. Cl. B29C 44/34; B29C 44/44; C08K 5/098

(52) U.S. Cl. CPC B29C 44/348; B29C 44/445; C08K 5/098; C08L 2205/025

(57) ABSTRACT

A foamed container prepared by foam injection molding of a polymer composition including a high melt strength polypropylene, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥30 cN.

### CROSS REFERENCE TO RELATED APPLICATIONS

This application is a National Stage Application of PCT/EP2023/080685, filed Nov. 3, 2023, which claims the benefit of European Application No. 22205600.4, filed Nov. 4, 2022, both of which are incorporated by reference in their entirety herein.

### BACKGROUND

The present invention relates to a foamed container and a process for preparing such foamed container.

Plastic crates or containers are nowadays widely used in many applications. Often the crates are used to pack and protect products in the field of consumer goods, food and grocery, automotive and others. Some of the crates need to insulate the heat or cold of the product that they protect. A typical example is the food crate for fast food delivery. The delivered product should be warm at arrival at the customer.

Another example is the food crate for fresh fish. These crates are on board of the fish vessel. After catching and cleaning of the fish, the fish is packed into the crate together with ice. The crate will be stored in the fridge. After arrival at the harbor, the fish is sold and delivered.

In the example of the fish crate, crates of polystyrene particle foams are typically used. Polystyrene particle foams have excellent insulation properties. Insulation properties is inversely proportional to the thermal conductivity (k) of the material; i.e., the lower the k-value is, the better the insulation performance is. The typical k-value for polystyrene particle foam is 0.035 W/m·K. Typically, solid HDPE has a k-value of 0.44 W/m·K and solid polypropylene has a k-value of 0.21 W/m·K.

Disadvantage of crates made of polystyrene particle foams is that these crates can be used only once. Due to the particle structure, microbes will hide in the pore structure of the material and affect the food.

### SUMMARY

It is an object of the present invention to provide a container which has good heat insulation properties and which is easy to clean and is re-usable.

Accordingly, the present invention provides a foamed container prepared by foam injection molding of a polymer composition comprising a high melt strength polypropylene.

### DETAILED DESCRIPTION

The foamed container according to the invention is easy to clean and is re-usable since it does not have a structure made of particles which makes the removal of microbes difficult. After its life time of e.g. using 30 times, the container can be advantageously recycled.

According to the invention, the use of the high melt strength polypropylene in combination with foam injection molding allows obtaining a foamed container with a very low density. The low density of the foamed container leads to high insulation properties and can even lead to insulation properties comparable to foamed containers made of polystyrene particles.

### Foam Injection Molding

Generally, to prepare a foamed article such as a foamed container, a polymer composition is mixed with a foaming agent. Then the mixture is heated to cause the polymer composition to melt and to cause the foaming agent to yield gas. Instead of first providing a mixture of a foaming agent and the polymer composition and subsequently melting the mixture to obtain a molten mixture, it is also possible to provide a melt of the polymer composition and mix a foaming agent into the melt of the polymer composition to obtain a molten mixture. Depending on the process, the resulting mixture is maintained as a gas laden melt until it is dispensed in a controlled manner through orifices or into shaping cavities. When the foaming is complete, the foamed article is allowed to solidify by cooling. Such processes are known in the art, e.g. from Thermoplastic Foams, by James L. Throne, Sherwood Publishers 1996, hereby incorporated by reference.

Preferably, the foam injection molding comprises sequential steps of:
providing a mixture of a foaming agent and a polymer composition comprising a high melt strength polypropylene;
melting the mixture to obtain a molten mixture;
injection molding the molten mixture into a mold;
optionally applying a pressure to the molten mixture in the mold;
opening the mold at least partially to allow the molten mixture to form a soft foamed article; and
allowing the soft foamed article to solidify to form the foamed container and eject the foamed container from the mold.

Preferably, the foam injection molding comprises sequential steps of:
a) providing a mixture of a foaming agent and the polymer composition and melting the mixture to obtain a molten mixture or b) providing a melt of the polymer composition and mixing a foaming agent in the melt of the polymer composition to obtain a molten mixture;
injection molding the molten mixture into a mold;
optionally applying a pressure to the molten mixture in the mold;
opening the mold at least partially to allow the molten mixture to form a soft foamed article; and
allowing the soft foamed article to solidify to form the foamed container and eject the foamed container from the mold.

Preferably, the step of injection molding the molten mixture into the mold is performed such that the mold is completely filled. This leads to a larger density reduction.

The pressure application step is preferred as this leads to a larger density reduction.

This process is sometimes referred as core-back injection molding process or a mold motion process. It was found that a particularly large density reduction and good insulation properties are achieved. The density reduction achieved may be at least 75%, i.e. the density of the foamed container may be at most 240 kg/m³.

Preferably, the foamed container has a density of at most 240 kg/m³, preferably at most 220 kg/m³, at most 200 kg/m³, at most 180 kg/m³ or at most 160 kg/m³, wherein the density is determined according to ISO 845 (2006).

In some preferred embodiments, the foamed container has a density of 160 to 320 kg/m³, more preferably 160 to 240 kg/m³, wherein the density is determined according to ISO 845 (2006). Such foamed container has a combination of good heat insulation properties and mechanical properties.

Preferably, the foamed container has a thermal conductivity value k of at most 0.100 W/mK, preferably 0.090 W/m·K, more preferably at most 0.080 W/m·K, more preferably at most 0.070 W/mK as determined by ASTM C518.

Preferably, the foamed container has a thermal conductance value U of at most 10.0 W/m²·K, more preferably at most 7.0 W/m²·K, more preferably at most 5.0 W/m²·K, as determined by ASTM C518.

Preferably, the foam injection molding according to the invention is performed by expanding a molten mixture having a thickness of t0 in a mold to the foamed container having a wall thickness of t1 at an expansion ratio EXP of 2.0 to 7.5, preferably 2.5 to 7.0, more preferably 3.0 to 6.5, more preferably 3.5 to 6.0, wherein EXP=t1/t0. Such process results in a foamed container has a combination of good heat insulation properties and mechanical properties.

In some preferred embodiments, the foam injection molding is performed by expanding a molten mixture having a thickness of t0 in a mold to the foamed container having a wall thickness of t1 at an expansion ratio EXP and wherein the foamed container has a thermal conductivity value k [W/mK] as determined by ASTM C518, wherein the following relation is satisfied:

$$0.1 * ( 1 / EXP ) + 0.025 \leq k \leq 0.5 * ( 1 / EXP ) - 0.0085 ,$$

wherein EXP=t1/t0

Such process results in a foamed container has a combination of good heat insulation properties and mechanical properties.

The present invention further provides a foamed container prepared by making foamed sheets by foam injection molding of a polymer composition comprising a high melt strength polypropylene and assembling the foamed sheets to obtain the foamed container, wherein the foam injection molding comprises sequential steps of:
a) providing a mixture of a foaming agent and the polymer composition and melting the mixture to obtain a molten mixture or b) providing a melt of the polymer composition and mixing a foaming agent in the melt of the polymer composition to obtain a molten mixture;
injection molding the molten mixture into a mold;
optionally applying a pressure to the molten mixture in the mold;
opening the mold at least partially to allow the molten mixture to form a soft foamed article; and
allowing the soft foamed article to solidify to form the foamed sheet and eject the foamed sheet from the mold.

The foamed sheets can be assembled into the foamed container by any known way, for example by using adhesives or by thermal bonding.

Preferably, the foam injection molding is performed by expanding a molten mixture having a thickness of t0 in a mold to the foamed sheet having a thickness of t1 at an expansion ratio EXP of 2.0 to 7.5, preferably 2.5 to 7.0, more preferably 3.0 to 6.5, more preferably 3.5 to 6.0, wherein EXP=t1/t0.

In some preferred embodiments, the foam injection molding is performed by expanding a molten mixture having a thickness of t0 in a mold to the foamed sheet having a wall thickness of t1 at an expansion ratio EXP and wherein the foamed sheet has a thermal conductivity value k [W/mK] as determined by ASTM C518, wherein the following relation is satisfied:

$$0.1 * ( 1 / EXP ) + 0.025 \leq k \leq 0.5 * ( 1 / EXP ) - 0.0085 ,$$

wherein EXP=t1/t0

The foaming agent used according to the invention can either be a physical foaming agent or a chemical foaming agent, wherein the chemical foaming agent is a chemical that decomposes at specific temperature to liberate gas(es), wherein physical foaming agent are either volatile liquids or gas(es). Typical chemical foaming agent includes but is not limited to azodicarbonamide, sodium bicarbonate, 5-phenyl tetrazole and citrate derivatives.

Preferably the foaming agent is a chemical foaming agent because it is easier to disperse a chemical foaming agent homogeneously in a polymer composition which leads to a more uniform foam structure. The chemical foaming agent can be in the form of powder or masterbatch.

A typical physical foaming agent includes but is not limited to fluids such as nitrogen, carbon dioxide, hydrocarbons (e.g. butane, pentane) in gaseous or supercritical state; and their mixtures.

The amount of the foaming agent used in the present invention can be varied depending on its nature and the foaming performance of the foaming agent. In some instances, the amount of the foaming agent varies in the range of 0.2-5.0 wt % based on the total weight of the polymer composition.

Preferably, the amount of the polymer composition with respect to the foamed container is at least 90 wt %, at least 95 wt %, at least 98 wt %, at least 99 wt % or 100 wt %.

### Polymer Composition

The polymer composition comprises a high melt strength polypropylene (HMS-PP). A high melt strength polypropylene is branched and, thus, differs from a linear polypropylene in that the polypropylene backbone covers side chains whereas a non-branched polypropylene, i.e. a linear polypropylene, does not cover side chains. The side chains have significant impact on the rheology of the polypropylene. Accordingly linear polypropylenes and high melt strength polypropylenes can be clearly distinguished by their flow behaviour under stress.

Branching can be generally achieved by using specific catalysts, i.e. specific single-site catalysts, or by chemical modification. Concerning the preparation of a branched polypropylene obtained by the use of a specific catalyst reference is made to EP 1 892 264. With regard to a branched polypropylene obtained by chemical modification it is referred to EP 0 879 830 A1. In such a case the branched polypropylene is also called high melt strength polypropylene.

Suitable examples of commercially available products of the high melt strength polypropylene are commercially available from Borealis AG under the trade name Daploy™, for example Daploy™ WB140HMS.

Another suitable example of commercially available products of the high melt strength polypropylene is Achieve™ Advanced PP6302E1 from Exxon Mobil.

Preferably, the high melt strength polypropylene has a melt strength of 30 cN. The melt strength of the high melt strength polypropylene is herein determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s2.

High melt strength polypropylene having a melt strength≥30 cN can for example be obtained by the process as disclosed in WO2009/003930A. WO2009/003930A1 discloses an irradiated polymer composition comprising at least one polyolefin resin and at least one non-phenolic stabilizer, wherein the irradiated polymer composition is produced by a process comprising mixing the polyolefin resin with the non-phenolic stabilizer and irradiating this mixture in a reduced oxygen environment. In addition, a high melt strength polypropylene having a melt strength≥45 cN is available from SABIC as SABIC® PP UMS 561 P as of 18 Feb. 2021.

Preferably, the high melt strength polypropylene is prepared by
a) irradiation of a polypropylene with at least one non-phenolic stabilizer, preferably wherein the non-phenolic stabilizer is chosen from the group of hindered amines, wherein the irradiation is performed with ≥2.0 and ≤20 Megarad electron-beam radiation in a reduced oxygen environment, wherein the amount of active oxygen is ≤15% by volume with respect to the total volume of the reduced oxygen environment for a time sufficient for obtaining a long chain branched polypropylene and
b) deactivation of the free radicals in the long chain branched polypropylene to form the high melt strength polypropylene.

How to deactivate the free radicals is known in the art, for example by heating as described in WO2009003930A1.

Examples of non-phenolic stabilizers are known in the art and are for example disclosed on pages 37-60 of WO2009/003930A1, hereby incorporated by reference. Preferably, the non-phenolic stabiizer is chosen from the group of hindered amines. More preferably, the non-phenolic stabilizer comprises at least one hindered amine selected from the group of Chimassorb® 944, Tinuvin®622, Chimassorb® 2020, Chimassorb® 119, Tinuvin®770, and mixtures thereof, separate or in combination with at least one hydroxylamine, nitrone, amine oxide, or benzofuranone selected from N,N-di(hydrogenated tallow)amine (Irgastab® FS-042), an N,N-di(alkyl)hydroxylamine produced by a direct oxidation of N,N-di(hydrogenated tallow)amine (Irgastab® FS-042), N-octadecyl-α-heptadecylnitrone, Genox™ EP, a di(C16-C18)alkyl methyl amine oxide, 3-(3,4-dimethylphenyl)-5,7-di-tert-butyl-benzofuran-2-one, Irganox® HP-136 (BFI), and mixtures thereof, and separate or in combination with at least one organic phosphite or phosphonite selected from tris(2,4-di-tert-butylphenyl) phosphite (Irgafos® 168). Even more preferably, the non-phenolic stabilizers of the present subject matter can include those described in U.S. Pat. Nos. 6,664,317 and 6,872,764, both of which are incorporated herein by reference in their entirety.

Preferably, the melt strength of the high melt strength polypropylene is ≥37 cN, preferably ≥40 cN, preferably ≥45 cN, more preferably 50 cN, more preferably ≥55 cN, even more preferably ≥60 cN, most preferably ≥65 cN and/or preferably the melt strength of the high melt strength polypropylene is ≤100 cN, for example ≤95 cN, for example ≤90 cN, for example ≤87 cN.

With polypropylene as used herein is meant propylene homopolymer, a copolymer of propylene with an α-olefin or a heterophasic propylene copolymer.

Preferably, the high melt strength polypropylene is polypropylene chosen from the group of propylene homopolymers and propylene copolymers comprising moieties derived from propylene and one or more comonomers chosen from the group of ethylene and alpha-olefins with ≥4 and ≤12 carbon atoms.

Preferably, the propylene copolymer comprises moieties derived from one or more comonomers chosen from the group of ethylene and alpha-olefins with ≥4 and ≤12 carbon atoms in an amount of ≤10 wt %, for example in an amount of ≥1.0 and ≤7.0 wt % based on the propylene copolymer, wherein the wt % is determined using ¹³C NMR. For example, the propylene copolymer comprises moieties derived from one or more comonomer chosen from the group of ethylene, 1-butene, 1-pentene, 1-hexene, 4-methyl-1-pentene, 1-heptene, 1-octene, 1-decene and 1-dodecene, preferably moieties derived from ethylene.

Polypropylenes and the processes for the synthesis of polypropylenes are known. A propylene homopolymer is obtained by polymerizing propylene under suitable polymerization conditions. A propylene copolymer is obtained by copolymerizing propylene and one or more other comonomers, for example ethylene, under suitable polymerization conditions. The preparation of propylene homopolymers and copolymers is for example described in Moore, E. P. (1996) Polypropylene Handbook. Polymerization, Characterization, Properties, Processing, Applications, Hanser Publishers: New York.

Propylene homopolymers, propylene copolymers and heterophasic propylene copolymers can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Preferably, the high melt strength polypropylene has a melt flow rate≥0.50 and ≤8.0 g/≥10 min, more preferably 0.70 and ≤5.0 g/10 min, most preferably ≥1.0 and ≤4.0 g/10 min as determined in accordance with ASTM D1238 (2013) at a temperature of 230° C. under a load of 2.16 kg.

Preferably, the high melt strength polypropylene has a VOC value as determined in accordance with VDA278 (2011-10)≤250 μg/g, preferably a VOC value≤50 μg/g and/or an FOG value as determined in accordance with VDA278 (2011-10)≤500 μg/g, preferably an FOG-value≤100 μg/g.

Preferably, the high melt strength polypropylene has a molecular weight distribution Mw/Mn of 5 to 20, preferably 7 to 17, most preferably 10 to 15. Mw and Mn may be measured by universal size exclusion chromatography (SEC), as described in ASTM D6474-12, using:
Chromatography: PolymerChar GPC-IR system running at 160° C.
Detection: Polymer Char IR5 infrared detector; PolymerChar viscometer
IR5 is used as concentration detector.
Column set: three Polymer Laboratories 13 μm PLgel Olexis, 300×7.5 mm
PE molar mass calibration was performed with linear PE standards (narrow and broad (Mw/Mn=4 to 15)) in the range of 0.5-2800 kg/mol
Concentration of samples injected are 0.03% m/m stabilized with Irgafos 168 and Topanol CA (weight ratio sample:Irgafos:Topanol=1:1:1)
Solvent and Eluent is 1,2,4-trichlorobenzene stabilized with 1 g/L BHT

Preferably, the amount of the high melt strength polypropylene with respect to the total polymer composition is at least 20 wt %, at least 30 wt %, at least 40 wt %, at least 50 wt %, at least 60 wt %, at least 70 wt %, at least 80 wt %, at least 90 wt %, at least 95 wt %, at least 98 wt %, at least 99 wt %, at least 99.5 wt %, at least 99.9 wt % or 100 wt %.

The polymer composition may comprise a further polypropylene which is not a high melt strength polypropylene. Said further polypropylene has a melt strength<30 cN. The melt strength of said further polypropylene may be <10 cN. The further polypropylene can be a propylene homopolymer, a propylene copolymer, for example a copolymer of propylene with an α-olefin as described herein or a heterophasic propylene copolymer.

For example, the amount of said further polypropylene with respect to the total polymer composition is 5 to 40 wt % or 40 to 80 wt %.

Preferably, the total amount of the high melt strength polypropylene and the further polypropylene with respect to the total polymer composition is at least 60 wt %, at least 70 wt %, at least 80 wt %, at least 90 wt %, at least 95 wt %, at least 98 wt %, at least 99 wt %, at least 99.5 wt %, at least 99.9 wt % or 100 wt %.

The polymer composition may further comprise additives, such as for example flame retardants, pigments, lubricants, slip agents flow promoters, antistatic agents, processing stabilizers, long term stabilisers and/or UV stabilizers. The additives may be present in any desired amount to be determined by the man skilled in the art, but are preferably present≥0.001 wt % and ≤5.0 wt %, more preferably ≥0.01 wt % and ≤4.0 wt %, even more preferably ≥0.01 wt % and ≤3.0 wt %, even more preferably ≥0.01 wt % and ≤2.0 wt % based on the polymer composition.

The polymer composition may further comprise a nucleating agent. A nucleating agent may be desired to increase the cell density and to modify the dynamics of bubble formation and growth. (Gendron, Thermoplastic foam Processing, 2005, page 209).

The amount of nucleating agent may for example be ≥0.010 wt % and ≤5.0 wt %, for example ≥0.030 wt % and ≤4.0 wt %, for example ≥0.050 wt % and ≤3.0 wt %, preferably ≥0.10 wt % and ≤2.5 wt %, more preferably ≥0.30 wt % and ≤1.5 wt % based on the polymer composition, most preferably ≥0.50 wt % and ≤1.2 wt % based on the polymer composition.

Suitable nucleating agents include but are not limited to talc, silica and a mixture of sodium bicarbonate and citric acid. Other suitable nucleating agents include amides, for example azo dicarbonamide, amines and/or esters of a saturated or unsaturated aliphatic (C₁₀-C₃₄) carboxylic acid. Examples of suitable amides include fatty acid (bis)amides such as for example stearamide, caproamide, caprylamide, undecylamide, lauramide, myristamide, palmitamide, behenamide and arachidamide, hydroxystearamides and alkylenediyl-bis-alkanamides, preferably (C₂-C₃₂) alkylenediyl-bis-(C₂-C₃₂) alkanamides, such as for example ethylene bistearamide (EBS), butylene bistearamide, hexamethylene bistearamide, ethylene bisbehenamide and mixtures thereof. Suitable amines include or instance (C₂-C₁₈) alkylene diamines such as for example ethylene biscaproamine and hexamethylene biscaproamine. Preferred esters of a saturated or unsaturated aliphatic (C₁₀-C₃₄) carboxylic acid are the esters of an aliphatic (C₁₆-C₂₄) carboxylic acid. Preferably, the nucleating agent is chosen from the group of talc, sodium bicarbonate, citric acid, azodicarbonamide and mixtures thereof, more preferably, the nucleating agent is talc.

For the preparation of the foamed container, it may be desired to use a cell stabilizer. Cell stabilizers are permeability modifiers which retard the diffusion of for example hydrocarbons such as isobutane to create dimensionally stable foams. (Gendron, Thermoplastic foam Processing, 2005, pages 31 and 149) Preferred cell stabilizers include but are not limited to glycerol monostearate (GMS), glycerol monopalmitate (GMP), palmitides and/or amides. Suitable amides are for example stearyl stearamide, palmitide and/or stearamide. Suitable mixtures include for example a mixture comprising GMS and GMP or a mixture comprising stearamide and palmitamide. Preferably, in case a cell stabilizer is used, the cell stabilizer is glycerol monostearate or stearamide.

The amount of cell stabilizer to be added depends on desired cell size and the polymer composition used for the preparation of the foamed container. Generally, the cell stabiliser may be added in an amount ≥0.10 and ≤3.0 wt % relative to the polymer composition.

Preferably, the foamed container has an open cell content of ≤15.0%, preferably ≤12.0%, more preferably ≤10.0%, even more preferably ≤7.0%, even more preferably ≤5.0%, even more preferably ≤4.0%, even more preferably ≤3.0%, even more preferably ≤2.0%, wherein the open cell content is determined according to ASTM D6226-10. Such foamed container has a combination of good heat insulation properties and mechanical properties.

The foamed container according to the invention may have any shape, for example a cuboid with a bottom wall and side walls, and any internal volume, for example 1.0 to 100 liter or 5.0 to 20 liter. For example, the internal volume may be 1 to 15 liter (e.g. 10 liter), 15 to 45 liter (e.g. 32 liter) or 45 to 100 liter (e.g. 70 liter).

The foamed container may have a wall thickness of 0.1 to 20 cm, 0.3 to 10 cm or 0.5 to 5.0 cm. For example, the wall thickness may be 0.1 to 3.0 cm, 3.0 to 10 cm or 10 to 20 cm.

The foamed container according to the invention has an opening so that products can be placed in the foamed container via the opening. The opening can be closed by a lid.

The invention further provides a lidded container comprising the foamed container according to the invention and a foamed lid for closing the foamed container.

Preferably, the foamed lid is also prepared by foam injection molding of a polymer composition comprising a high melt strength polypropylene.

Suitable polymer compositions for preparing the lid are those described for the foamed container according to the invention. Preferably, the polymer composition of the foamed container and the polymer composition of the lid are of the same type. It will be appreciated that this means that the same polymer composition is used to obtain the foamed container and the foamed lid.

Suitable processes for foam injection molding are those described for the foamed container according to the invention. Preferably, the lid is prepared by the core-back injection molding process.

The lid may have a wall thickness of 0.1 to 20 cm, 0.3 to 10 cm or 0.5 to 5.0 cm. For example, the wall thickness may be 0.1 to 3.0 cm, 3.0 to 10 cm or 10 to 20 cm.

The invention further provides use of the foamed container according to the invention or the lidded container according to the invention for storing and/or transporting food.

The invention further provides a process for preparing a foamed container comprising foam injection molding of a polymer composition comprising a high melt strength polypropylene.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

When values are mentioned for a lower limit and an upper limit for a parameter, ranges made by the combinations of the values of the lower limit and the values of the upper limit are also understood to be disclosed.

The invention is now elucidated by way of the following examples, without however being limited thereto.

FIG. 1 illustrates an example of a lidded container comprising a foamed container according to the invention in an open state and

FIG. 2 illustrates an example of a lidded container comprising a foamed container according to the invention in a closed state.

Performance of containers with same inner dimensions of 360 mm×360 mm×100 mm (13 liter) was modelled via the Fourier heat transfer model:

$$\dot{Q} = \frac{E}{A} = U ( {T}_{o} - {T}_{i} )$$

The amount of heat uptake or transfer per second (E) into the box to heat up the 5 kg ice content is related to the thermal conductance across the wall of the foam container (U); the total outer surface area of the container including lid (A); and the temperature difference between the outer and inner surface of the container. Taking that the outer surface of the container (Tₒ) is at a constant temperature of 20° C., the inner temperature of the container (Tᵢ) remains at 0° C. prior to complete melting of the ice content, the equation will be simplified to

$$E = U A ( 20 )$$

The U-value of the container wall is related to the thermal conductivity or k-value (k) and thickness (t) of the wall material:

$$U = \frac{k}{t}$$

For each kilogram of ice, it takes 333550J of heat energy to melt; thus, it takes 1667750J to completely melt the 5 kg content of ice. Hence, it is possible to estimate the total amount of time that the container can prevent complete melting of the 5 kg ice content:

$$Time to melt all ice = \frac{1667750}{E}$$

Based on the above calculation, the time to melt 5 kg of ice placed in lidded containers made from different materials were determined.

Comparative Example 1 represents an injection molded container of unfoamed PP having wall thickness of 2 cm. Typical k-value of such material is 0.21 W/m·K. Such container will only keep the 5 kg ice content from complete melting for 4.1 hours.

Comparative Example 2 represents a foam injection molded container of a linear polypropylene with 50% density reduction (i.e., 475 kg/m³) having wall thickness of 2 cm. Typical k-value of such material is 0.1032 W/m·K. Even with foaming, such container (with only 50% density reduction) will only keep the 5 kg ice content from complete melting for 8.3 hours.

Comparative Example 3 represents a foam injection molded container with the same material as Comparative Example 2 (i.e., 475 kg/m³) but with a thicker wall thickness of 4 cm. Even with doubling the wall thickness, such container will keep the 5 kg ice content from complete melting for 12.8 hours.

Example 1 represents a foam injection molded container of a high melt strength polypropylene (PP-UMS) with 75% density reduction (i.e. 235 kg/m³) having wall thickness of 2 cm. Typical k-value of such material is 0.0628 W/m·K. This container will keep the 5 kg ice content from complete melting for 13.6 hours.

Example 2 represents a foam injection molded container of PP-UMS-based resin with 80% density reduction (i.e. 190 kg/m³) having wall thickness of 2 cm. Typical k-value of such material is 0.0551 W/m·K. This container will keep the 5 kg ice content from complete melting for 15.5 hours.

Example 3 represents a foam injection molded container of PP-UMS-based resin with 80% density reduction (i.e. 190 kg/m³) having wall thickness of 3 cm. This container will keep the 5 kg ice content from complete melting for 20.3 hours.

Example 4 represents a foam injection molded container of PP-UMS-based resin with 83% density reduction (i.e. 158 kg/m³) having wall thickness of 3 cm. Typical k-value of such material is 0.0504 W/m·K. This container will keep the 5 kg ice content from complete melting for 22.2 hours.

Example 5 represents a foam injection molded container of PP-UMS-based resin with 83% density reduction (i.e. 190 kg/m³) having wall thickness of 4 cm. This container will keep the 5 kg ice content from complete melting for 23.9 hours.

Comparative Example 4 represents an injection molded container of unfoamed HDPE having wall thickness of 2 cm. Typical k-value of such material is 0.44 W/m·K. Such container will only keep the 5 kg ice content from complete melting for 1.9 hours.

Comparative Example 5 represents a foam injection molded container of conventional HDPE with 50% density reduction (i.e., 478 kg/m³) having wall thickness of 4 cm. Typical k-value of such material is 0.195 W/m·K. Even with foaming and doubled wall thickness, such container will only keep the 5 kg ice content from complete melting for 6.7 hours.

Comparative Example 6 represents container made with particle polystyrene foam having wall thickness of 2 cm. Typical k-value of such material is 0.035 W/m·K. This container will keep the 5 kg ice content from complete melting for 24.3 hours.

The results are summarized in the table below. With the lower density achieved by the use of PP-UMS, foam injection molded containers with improved insulation performance could thus be attainable, enabling the possibility of utilizing these containers as returnable and recyclable insulation crates/containers.

| Example | | Comp Ex1 | Comp Ex2 | Comp Ex3 | Ex 1 | Ex 2 | Ex 3 |
|---|---|---|---|---|---|---|---|
| Base-resin | | PP | PP | PP | PP-UMS | PP-UMS | PP-UMS |
| Container | m | 0.4 | 0.4 | 0.44 | 0.4 | 0.4 | 0.42 |
| length (L) | | | | | | | |
| Container | m | 0.4 | 0.4 | 0.44 | 0.4 | 0.4 | 0.42 |
| width (W) | | | | | | | |
| Container | m | 0.14 | 0.14 | 0.18 | 0.14 | 0.14 | 0.16 |
| height (D) | | | | | | | |
| Container wall | cm | 2 | 2 | 4 | 2 | 2 | 3 |
| thickness (t) | | | | | | | |
| Outer surface area | m2 | 0.544 | 0.544 | 0.704 | 0.544 | 0.544 | 0.6216 |
| (5 faces + lid) | | | | | | | |
| Container | m3 | 0.013 | 0.013 | 0.013 | 0.013 | 0.013 | 0.013 |
| Inner volume | | | | | | | |
| Wall material | kg/m3 | 950 | 475 | 475 | 235 | 190 | 190 |
| density | | | | | | | |
| k-value | W/-m-K | 0.21 | 0.1032 | 0.1032 | 0.0628 | 0.0551 | 0.0551 |
| U-value | W/m2-K | 10.50 | 5.16 | 2.58 | 3.14 | 2.76 | 1.84 |
| Ice Content | kg | 5 | 5 | 5 | 5 | 5 | 5 |
| Energy to melt all ice | J | 1667750 | 1667750 | 1667750 | 1667750 | 1667750 | 1667750 |
| T inside (Tᵢ) | C. | 0 | 0 | 0 | 0 | 0 | 0 |
| T outside (Tₒ) | C. | 20 | 20 | 20 | 20 | 20 | 20 |
| Heat uptake per | J/s | 114.24 | 56.14 | 36.33 | 34.16 | 29.97 | 22.83 |
| box per second (E) | | | | | | | |
| Time to melt all ice | Hours | 4.1 | 8.3 | 12.8 | 13.6 | 15.5 | 20.3 |

| Example | | Ex 4 | Ex 5 | Comp Ex4 | Comp Ex5 | Comp Ex6 |
|---|---|---|---|---|---|---|
| Base-resin | | PP-UMS | PP-UMS | HDPE | HDPE | PS |
| Container | m | 0.42 | 0.44 | 0.4 | 0.44 | 0.4 |
| length (L) | | | | | | |
| Container | m | 0.42 | 0.44 | 0.4 | 0.44 | 0.4 |
| width (W) | | | | | | |
| Container | m | 0.16 | 0.18 | 0.14 | 0.18 | 0.14 |
| height (D) | | | | | | |
| Container wall | cm | 3 | 4 | 2 | 4 | 2 |
| thickness (t) | | | | | | |
| Outer surface area | m2 | 0.6216 | 0.704 | 0.544 | 0.704 | 0.544 |
| (5 faces + lid) | | | | | | |
| Container | m3 | 0.013 | 0.013 | 0.013 | 0.013 | 0.013 |
| Inner volume | | | | | | |
| Wall material | kg/m3 | 158 | 190 | 953 | 478 | 50 |
| density | | | | | | |
| k-value | W/-m-K | 0.0504 | 0.0551 | 0.44 | 0.195 | 0.035 |
| U-value | W/m2-K | 1.68 | 1.38 | 22.00 | 4.88 | 1.75 |
| Ice Content | kg | 5 | 5 | 5 | 5 | 5 |
| Energy to melt all ice | J | 1667750 | 1667750 | 1667750 | 1667750 | 1667750 |
| T inside (Tᵢ) | C. | 0 | 0 | 0 | 0 | 0 |
| T outside (Tₒ) | C. | 20 | 20 | 20 | 20 | 20 |
| Heat uptake per | J/s | 20.89 | 19.40 | 239.36 | 68.64 | 19.0 |
| box per second (E) | | | | | | |
| Time to melt all ice | Hours | 22.2 | 23.9 | 1.9 | 6.7 | 24.3 |

Polypropylene having a melt strength of more than 65 cN (SABIC PP-UMS 561 P) was pre-mixed with 0.5 wt % Avient Hydrocerol CF 40E (masterbatch containing mixture of bicarbonate and citrate derivatives) as foaming agent and nucleating agent to obtain polypropylene composition to be subjected to foam injection molding. Carbon black and an impact polypropylene copolymer SABIC PP FPC45 were also used to obtain the polypropylene compositions in some examples as shown in Table 2.

The obtained polypropylene compositions were loaded in an injection molding machine that has a 50 mm-diameter screw and a 150-ton clamping unit. The machine is also equipped with Trexel MuCell T-100 system for dosing 1.5 wt % carbon dioxide blowing agent for foam injection molding. The mold tool used comprises a fixed half and a moveable half. When the two halves are closed, the tool has a mold cavity of 90 mm-wide×160 mm-long rectangular plaque geometry. Gas-laden PP material was first injected to fill the closed mold cavity. In the subsequent step, the movable half of the mold tool retrieves partially to an intermediate position, enabling the gas-laden material in the cavity to foam and expand from the initial (cavity) thickness, t0, to the final foam thickness, t1. Foam with different densities were achieved by controlling the ratios between t1 and t0 (expansion ratio EXP). The foam was further cooled in the mold to solidify, and later, ejected from the mold.

Thermal conductivity (k) values of the obtained plaques were measured with a heat flow meter (HFM 446 Lambda Small by NETZSCH) under the conditions of ASTM C518. Results are shown in Table 2.

TABLE 2

| | | 100% UMS | 100% UMS | 100% UMS | 100% UMS | 30% UMS + 70% FPC45 |
|---|---|---|---|---|---|---|
| | | Natural | Natural | Natural | Black | Black |
| Initial thickness | t0 [mm] | 3 | 3 | 3 | 3 | 3 |
| Foamed thickness | t1 [mm] | 9 | 12 | 15 | 15 | 15 |
| Overall Expansion | EXP [x] | 3 | 4 | 5 | 5 | 5 |
| Foam density | p [kg/m3] | 302 | [symbol] | [symbol] | [symbol] | [symbol] |
| Thermal conductivity | k [W/mK] | 0.079 | 0.071 | 0.064 | [symbol] | 0.056 |
| Thermal conductance | U [W/m2K] | [symbol] | 5.9 | 4.3 | 4.4 | 3.8 |

[symbol]

indicates data missing or illegible when filed

Low thermal conductivity (k value) and low thermal conductance (U value) were obtained even though the expansion ratio was relatively low.

1. A foamed container prepared by foam injection molding of a polymer composition comprising a high melt strength polypropylene, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥30 cN.

2. The foamed container according to claim 1, wherein the high melt strength polypropylene has a melt strength determined in accordance with ISO 16790:2005 at a temperature of 200° C., using a cylindrical capillary having a length of 20 mm and a width of 2 mm, a starting velocity v0 of 9.8 mm/s and an acceleration of 6 mm/s² of ≥40 cN, and/or the melt strength of the high melt strength polypropylene is ≤100 cN.

3. The foamed container according to claim 1, wherein the high melt strength polypropylene has a molecular weight distribution Mw/Mn of 5 to 20, measured by universal size exclusion chromatography as described in ASTM D6474-12.

4. The foamed container according to claim 1, wherein the foam injection molding is performed by expanding a molten mixture having a thickness of t0 in a mold to the foamed container having a wall thickness t1 at an expansion ratio EXP of 2.0 to 7.5, wherein EXP=t1/t0.

5. The foamed container according to claim 1, wherein the foamed container has a thermal conductivity value k of at most 0.100 W/mK, and/or a thermal conductance value U of at most 10.0 W/m²K, as determined by ASTM C518.

6. The foamed container according to claim 1, wherein the foam injection molding is performed by expanding a molten mixture having a thickness of t0 in a mold to the foamed container having a wall thickness of t1 at an expansion ratio EXP and wherein the foamed container has a thermal conductivity value k [W/mK] as determined by ASTM C518, wherein the following relation is satisfied:
$$0.1 * ( 1 / EXP ) + 0.025 \leq k \leq 0.5 * ( 1 / EXP ) - 0.0085 ,$$
wherein EXP=t1/t0.

7. The foamed container according to claim 1, wherein the foamed container has an open cell content of ≤15.0%, wherein the open cell content is determined according to ASTM D6226-10.

8. The foamed container according to claim 1, wherein the foam injection molding comprises sequential steps of:
a) providing a mixture of a foaming agent and the polymer composition and melting the mixture to obtain a molten mixture or b) providing a melt of the polymer composition and mixing a foaming agent in the melt of the polymer composition to obtain a molten mixture;
injection molding the molten mixture into a mold;
optionally applying a pressure to the molten mixture in the mold;
opening the mold at least partially to allow the molten mixture to form a soft foamed article; and
allowing the soft foamed article to solidify to form the foamed container and eject the foamed container from the mold.

9. The foamed container according to claim 1, wherein the amount of the high melt strength polypropylene with respect to the total polymer composition is at least 20 wt %.

10. The foamed container according to claim 1, wherein the polymer composition comprises a further polypropylene which is not a high melt strength polypropylene.

11. The foamed container according to claim 1, wherein the foamed container has a wall thickness of 0.1 to 20 cm.

12. The foamed container according to claim 1, wherein the foamed container has an internal volume of 1 to 100 liter.

13. A lidded container comprising the foamed container according to claim 1 and a foamed lid for closing the foamed container.

14. A method for storing and/or transporting food, the method comprising packing the food into the foamed container according to claim 1.

15. A process for preparing a foamed container comprising foam injection molding of a polymer composition comprising a high melt strength polypropylene,
wherein the high melt strength polypropylene has a melt strength determined in accordance with ISO 16790:2005 at a temperature of 200° C., using a cylindrical capillary having a length of 20 mm and a width of 2 mm, a starting velocity vs of 9.8 mm/s and an acceleration of 6 mm/s² of ≥30 cN.
